(19) United States
(12) Patent Application Publication
(10) Pub. No.: US 2015/0039351 A1
(43) Pub. Date: Feb. 5, 2015

(54) Categorizing Life Insurance Applicants to Determine Suitable Life Insurance Products

(71) Applicant: Transamerica Corporation, San Francisco, CA (US)

(72) Inventors: Paul Bell, Allen, TX (US); Angela B. Williams, Sanger, TX (US)

(21) Appl. No.: 14/336,672

(22) Filed: Jul. 21, 2014

Related U.S. Application Data
(60) Provisional application No. 61/861,605, filed on Aug. 2, 2013.

(51) Int. Cl. G06Q 40/08

(52) U.S. Cl. CPC G06Q 40/08
USPC 705/4

(57) ABSTRACT

Methods and apparatuses, including computer program products, are described for categorizing a life insurance applicant to determine one or more suitable insurance products. A computing device receives data associated with the applicant. The computing device determines a risk level for one or more insurance risk factors, an insurance need factor, and an insurance probability factor associated with the applicant based on the received data. The computing device combines the risk level, the insurance need factor, and the insurance purchase probability to generate an insurance suitability profile associated with the applicant. The computing device identifies one or more insurance products available to the applicant based on the insurance suitability profile.

### RELATED APPLICATIONS

This application claims priority to U.S. Provisional Patent Application No. 61/861,605, filed on Aug. 2, 2013, the entirety of which is incorporated herein by reference.

### FIELD OF THE INVENTION

The subject matter of this application relates generally to methods and apparatuses, including computer program products, for categorizing life insurance applicants to determine suitable life insurance products.

### BACKGROUND

The underwriting phase is the most time-consuming and costly part of the life insurance application process. Insurance companies devote significant time and resources to applications, many of which ultimately are declined—or the applicants are offered insurance products that they do not need, cannot afford or would likely never purchase.

Often, an applicant will submit an application and wait for several weeks or months while the application is reviewed by the insurance company. The underwriting process traditionally involves manual analysis of complex data, such as medical records, to determine an applicant's risk profile and eligibility for certain types of life insurance. In addition, important factors such as an applicant's need and ability to afford life insurance, and an applicant's likelihood of purchasing life insurance, are given little to no consideration.

### SUMMARY

In general overview, the techniques described herein are related to using a computerized system to categorize a life insurance applicant, using a variety of information associated with the applicant, to determine the suitability of life insurance products for the applicant. The techniques leverage the processing speed and power of a computer-based system to provide the advantage of assessing the insurance risk, insurance need, and probability of insurance purchase for a particular applicant to quickly determine whether the applicant is eligible for one or more insurance products. The computer-based system can use a multitude of advanced data sources, algorithms, and modeling techniques to provide an underwriting evaluation of the applicant much faster than traditional underwriting processes yet still retaining a high level of confidence in the underwriting determination. The techniques also provide a more targeted evaluation of each applicant to result in greater efficiency when identifying the viability of both current applicants and potential applicants for life insurance products offered by an insurance company.

The invention, in one aspect, features a computerized method for categorizing a life insurance applicant to determine one or more suitable insurance products. A computing device receives data associated with the life insurance applicant. The computing device determines a risk level for one or more insurance risk factors associated with the applicant based on the received data. The computing device determines an insurance need factor associated with the applicant based on the received data. The computing device determines an insurance purchase probability associated with the applicant based on the received data. The computing device combines the risk level, the insurance need factor, and the insurance purchase probability to generate an insurance suitability profile associated with the applicant. The computing device identifies one or more insurance products available to the applicant based on the insurance suitability profile.

The invention, in another aspect, features system for categorizing a life insurance applicant to determine one or more suitable insurance products. The system includes a computing device configured to receive data associated with the life insurance applicant. The computing device is configured to determine a risk level for one or more insurance risk factors associated with the applicant based on the received data, determine an insurance need factor associated with the applicant based on the received data, and determine an insurance purchase probability associated with the applicant based on the received data. The computing device is configured to combine the risk level, the insurance need factor, and the insurance purchase probability to generate an insurance suitability profile associated with the applicant. The computing device is configured to identify one or more insurance products available to the applicant based on the insurance suitability profile.

The invention, in another aspect, features a computer program product, tangibly embodied in a computer readable storage medium, for categorizing a life insurance applicant to determine one or more suitable insurance products. The computer program product includes instructions operable to cause a computing device to receive data associated with the life insurance applicant. The computer program product includes instructions operable to cause the computing device to determine a risk level for one or more insurance risk factors associated with the applicant based on the received data, determine an insurance need factor associated with the applicant based on the received data, and determine an insurance purchase probability associated with the applicant based on the received data. The computer program product includes instructions operable to cause a computing device to combine the risk level, the insurance need factor, and the insurance purchase probability to generate an insurance suitability profile associated with the applicant. The computer program product includes instructions operable to cause a computing device to identify one or more insurance products available to the applicant based on the insurance suitability profile.

In some embodiments, any of the above aspects can include one or more of the following features. In some embodiments, the received data includes at least one of: demographic data, personal medical history data, family medical history data, pharmacy/prescription data, criminal record data, motor vehicle data, occupation data, travel data, financial data, beneficiary data, prior/concurrent insurance coverage data, insurance application data, substance abuse data, and accident data.

In some embodiments, the step of determining a risk level for one or more insurance risk factors comprises generating a predictive risk associated with future activities based on the received data. In some embodiments, the risk level is a scaled value based on an aggregation of the one or more risk factors. In some embodiments, the aggregation of the one or more risk factors includes weighting each risk factor according to predetermined criteria. In some embodiments, the risk level represents the likelihood that an insurable event will happen to the applicant.

In some embodiments, the step of determining a risk level for one or more insurance risk factors comprises calibrating the risk level against known mortality information. In some embodiments, the step of determining a risk level for one or more insurance risk factors comprises comparing the risk factors to risk factors associated with prior life insurance applicants.

In some embodiments, the step of determining an insurance need factor comprises generating a predictive need for future life insurance coverage based on the received data. In some embodiments, the insurance need factor represents the applicant's need for life insurance and the applicant's ability to afford life insurance. In some embodiments, the insurance need factor is determined based on one or more of: income, net worth, marital status, number of children/dependents, prior/concurrent life insurance, and credit history.

In some embodiments, the insurance purchase probability represents a likelihood that the applicant will avoid letting a purchased life insurance policy lapse. In some embodiments, the insurance purchase probability relates to one or more identified insurance products.

In some embodiments, the insurance suitability profile represents a determination of whether the applicant has satisfied underwriting requirements of the insurance company and is eligible to be offered one or more insurance products. In some embodiments, the insurance suitability profile indicates whether additional underwriting is required for the applicant.

In some embodiments, the computing device transmits, to the applicant, information about the available life insurance products, if at least one available life insurance product is identified. In some embodiments, the computing device receives, from the applicant, a completed life insurance application. In some embodiments, the computing device stores the received data for subsequent sales and marketing purposes.

The aspects of the invention include computer-based implementations such as a computer system including software modules and hardware modules, connected to a communications network and operable to perform the methods and processes described herein. The computer system can comprise one or several processor-based computing devices that control physical and/or logical modules to implement aspects of the invention. The devices comprising the computing system can be distributed across several locations that, in some examples, are geographically distinct. The functionality and resources of the system can likewise be distributed across several of the devices as described herein. Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for categorizing life insurance applicants to determine suitable life insurance products.

FIG. 2 is a block diagram of a networked system for categorizing life insurance applicants to determine suitable life insurance products.

FIG. 3 is a detailed block diagram of the insurance suitability module.

FIG. 4 is a flow diagram of a method for categorizing life insurance applicants to determine suitable life insurance products.

### DETAILED DESCRIPTION

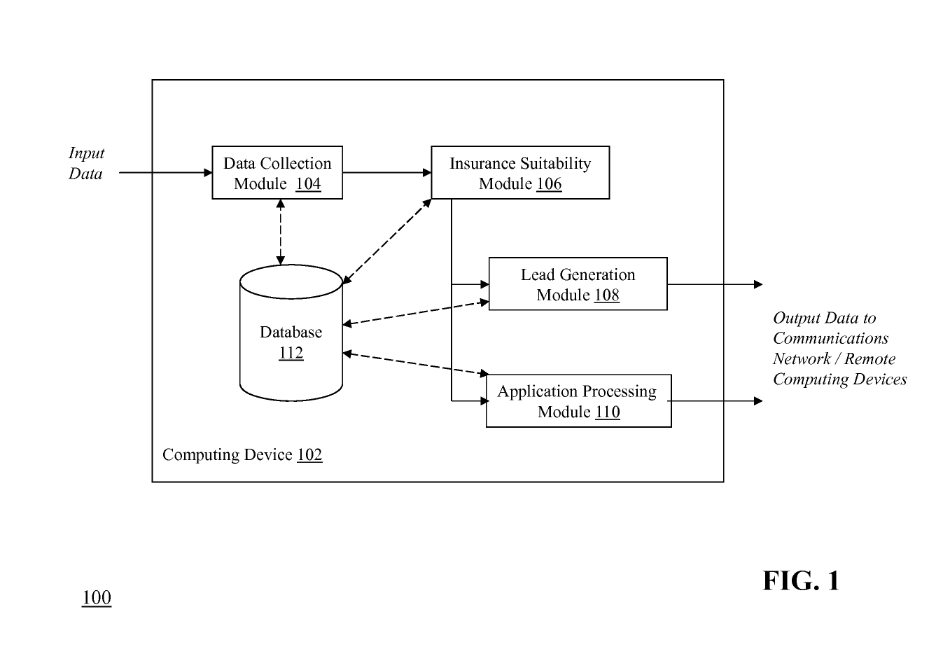

FIG. 1 is a block diagram of a system 100 for categorizing life insurance applicants to determine suitable life insurance products. The system 100 includes a computing device 102 for implementing the computer processing in accordance with computer-implemented embodiments of the invention. The methods described herein may be achieved by implementing program procedures, modules and/or software executed on, for example, a processor-based computing devices or network of computing devices. The computing device 102 is connected to one or more communications networks that enable the computing device to receive data from and transmit data to other computing devices that assist the computing device 102 in performing the processes described herein.

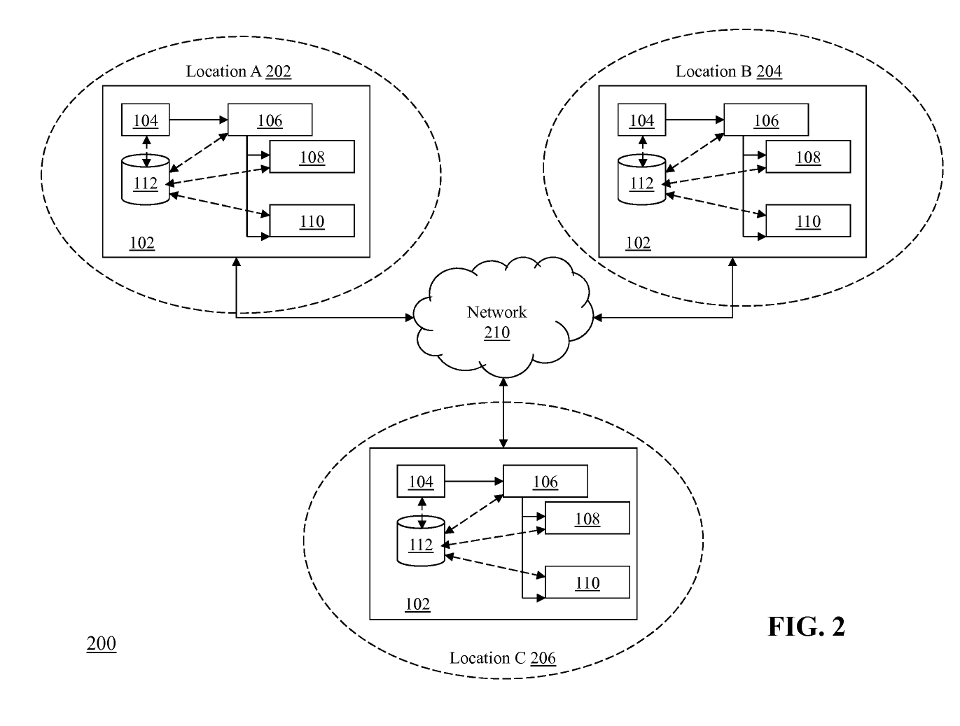

The techniques may be implemented in a networked system 200 comprising multiple computing devices distributed across different locations, as shown in FIG. 2. Each of Location A 202, Location B 204 and Location C 206 includes the computing device 102 having enumerated components 104, 106, 108, 110, 112 of FIG. 1, and the computing devices at locations 202, 204, and 206 are connected to each other via the network 210. The networked system of FIG. 2 enables distribution of the processing functions described herein across several computing devices and provides redundancy in the event that a computing device at one location is offline or inoperable. In some embodiments, remote computing devices in proximity to a particular location (e.g., Location A 202) access the networked system via the computing device 102 at that location. In some embodiments, the computing devices 102 at the respective locations 202, 204, 206 communicate with a central computing device 212 (e.g., a server) that is coupled to the network. The central computing device 212 can provide data and/or processing resources for the network of computing devices 102 (e.g., synchronization of functionality/data across the computing devices).

The computing device 102 is configurable to include automated processing for the methods of the invention, such as triggering mechanisms that evaluate certain data and system events, and respond to determinations made through use of the triggering mechanisms by performing additional actions.

The computing device 102 includes a data collection module 104, an insurance suitability module 106, a lead generation module 108, an application processing module 110, and a database 112. The data collection module 104, insurance suitability module 106, lead generation module 108, and application processing module 110 are hardware and/or software modules located in the computing device 102 and used to execute the method for categorizing life insurance applicants to determine suitable life insurance products. In some embodiments, the computing device 102 is a server computing device located on a communication network (e.g., Internet, WAN, or LAN) and communicating with other computing devices (not shown). In some embodiments, the functionality of the data collection module 104, insurance suitability module 106, lead generation module 108, and application processing module 110 is distributed among a plurality of computing devices. Additionally, in some embodiments, the database 112 is located on a different computing device that is coupled to the computing device 102. It should be appreciated that any number of computing devices, arranged in a variety of architectures, resources, and configurations (e.g., cluster computing, virtual computing, cloud computing) can be used without departing from the scope of the invention.

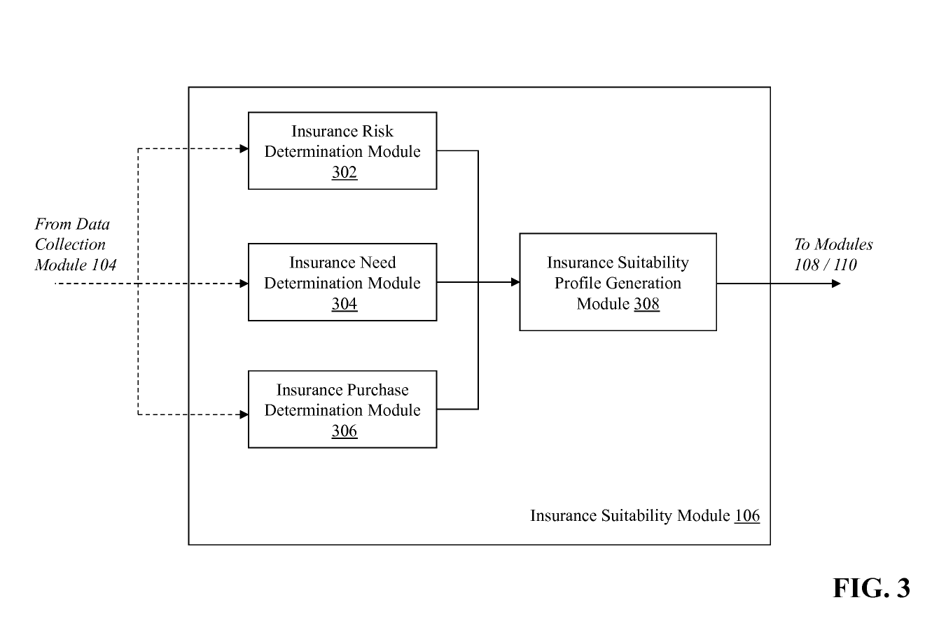

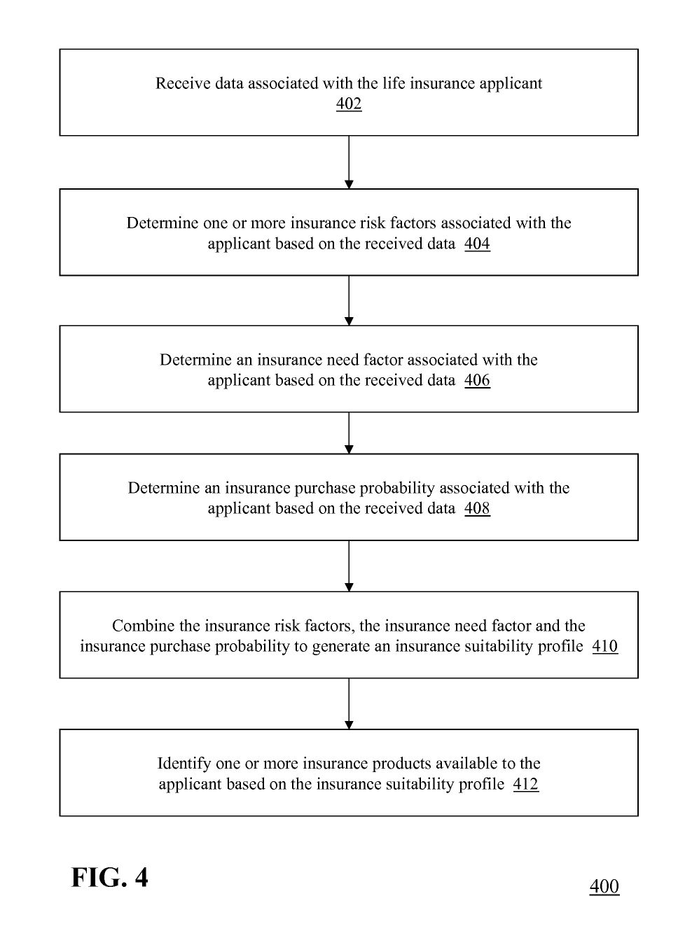

FIG. 3 is a detailed block diagram of the insurance suitability module 106 of FIG. 1. The insurance suitability module 106 includes an insurance risk determination module 302, an insurance need determination module 304, an insurance purchase determination module 306, and an insurance suitability profile generation module 308. The functionality of the modules 302, 304, 306 and 308 is explained in greater detail below with reference to FIG. 4.

FIG. 4 is a flow diagram of a method 400 for categorizing life insurance applicants to determine suitable life insurance products, using the system 100 of FIG. 1 and the insurance suitability module of FIG. 3. The computing device 102 receives (402) data associated with a life insurance applicant via the data collection module 104. The received data can comprise a variety of information points or variables that relate to a characteristic or attribute of the life insurance applicant. The data can be received from any number of data sources and/or data feeds (e.g., proprietary and/or third-party data repositories) that are coupled to the computing device 102. For example, the data sources can include, but are not limited to: pharmacy records, motor vehicle records, medical/health history records (e.g., Medical Information Bureau (MIB)), criminal records, employment information, demographic information, financial information, credit score information, travel information, prior/concurrent insurance information, applicant questionnaires, and the like. The data collection module 104 can categorize the received data according to established criteria, such as subject matter. The data collection module 104 communicates with the database 112 to index and store the received data.

In some embodiments, the receipt of data by the data collection module 104 is initiated upon submission of a completed life insurance application by the applicant. The applicant can submit an application through a variety of channels (e.g., paper, website form, electronic file). Also, the applicant can submit an application through an agent or broker that collects application information from the applicant and submits the application to the insurance company. In some embodiments, the insurance company reviews the application to ensure it is complete and properly submitted (e.g., the applicant has signed the application and authorized the insurance company to obtain additional information from third-party sources). Once the application is submitted, the computing device 102 initiates collection of data associated with the applicant from the data sources, as described previously. In some embodiments, the computing device 102 has already collected certain information associated with the applicant from available data sources—even before the applicant has submitted the application—and stored the information in the database 112 (i.e., for lead generation purposes, as will be described below).

Once the data is received by the computing device 102, the insurance suitability module 106 determines (404) one or more insurance risk factors associated with the applicant using the received data. The insurance risk determination module 302 receives applicant data from the data collection module 104 and analyzes the applicant data using statistical modeling techniques and metrics to determine the insurance risk factors. Example risk factors include, but are not limited to:

| Risk Factor | Type of Risk(s) Involved | Example Data Source |
|---|---|---|
| Travel | Death in foreign country | Insurance application; MIB |
| | (accident, violence, disease) | |
| Avocation | Accidental death | Insurance application; MIB |
| Aviation | Accidental death | Insurance application; MIB |
| Occupation | Accidental death and disease | Insurance application; MIB |
| Residency | Persistency (e.g., likelihood of | Insurance application |
| | insurance being maintained); | |
| | claims investigation risk; | |
| | mortality risk; fraud | |
| Citizenship | Persistency; claims investigation | Insurance application |
| | risk; mortality risk; fraud | |
| Medical | Death by disease | Insurance application; Health |
| | | care database; MIB; pharmacy |
| | | database; clinical lab database |
| Motor Vehicle | Accidental death | Insurance application; MIB, |
| | | motor vehicle records |
| Insurable Interest | Legal - legitimacy of beneficiary | Insurance application |
| Financial | Persistency; overinsurance | Insurance application; MIB; |
| | | credit report data |
| Family History | Death by disease | Insurance application; MIB; |
| | | motor vehicle records; criminal |
| | | records; health care database |
| Substance Abuse | Death by disease | Insurance application; MIB; |
| (alcohol/drug) | | motor vehicle records; criminal |
| | | records; health care database |
| Substance Abuse | Death by disease | Insurance application; MIB; other |
| (tobacco) | | in-force insurance policy data |
| Replacement | Overinsurance | Insurance application |

The insurance risk determination module 302 performs analyses of the data associated with each risk factor to determine a level of risk corresponding to each of the respective risk factors. The analysis can use algorithms and methodologies (e.g., internal business rules, comparison with actuarial and/or underwriting criteria, individual or population-based modeling) that are configured to produce a quantifiable level of risk. The level of risk can be compared with a threshold to determine whether the level of risk associated with the life insurance applicant is acceptable in order for the insurance company to insure the applicant. In some embodiments, the levels of risk for each risk factor combined to result in an overall level of risk. In some embodiments, the level of risk for each risk factor can be evaluated with an equal weight, or the levels of risk for each risk factor can be weighted according to a respective severity level (e.g., the Medical risk factor for a 65 year-old retired applicant can be given more weight than the Occupation risk factor).

The insurance risk determination module 302 also includes modeling techniques to determine future, or predictive, risk associated with one or more of the risk factors. For example, the insurance risk determination module 302 can identify significant events in the family medical history associated with the applicant (e.g., cancer, heart disease, diabetes) and use probabilistic techniques in conjunction with known statistics to determine whether the applicant has an increased future risk for the same or similar medical events.

In some embodiments, the insurance risk determination module 302 need not evaluate every risk factor. Instead, the insurance risk determination module 302 may evaluate only a specific subset of risk factors, based on criteria established by the insurance company. For example, the insurance risk determination module 302 may not evaluate a specific risk factor if data corresponding to that risk factor cannot be obtained for an applicant

Once the insurance risk determination module 302 has evaluated the risk factor data and generated a level of risk associated with the risk factors, the insurance risk determination module 302 can produce the results of its evaluation as a scaled numeric value. The scaled value represents the confidence that the applicant meets a certain classification (e.g., Standard) for life insurance. The scaled value can be based on a predefined scale (e.g., 0-100) where a higher value represents a lower level of risk associated with the applicant. In some embodiments, the scaled value can be calibrated against existing data to minimize the chance of erroneous results. For example, the scaled value can be calibrated back to a known mortality process (e.g., Clinical Reference Laboratory (CRL)). In another example, the scaled value can be validated against existing applicant data—the scaled value for an applicant under evaluation can be compared with the scaled values for previous applicants having similar risk factor data. The insurance risk determination module 302 can determine whether the scaled value for the applicant under evaluation falls outside of an expected range based on the previous applicant data and conduct additional analysis on the applicant under evaluation, or transmit the application for manual review.

The insurance need determination module 304 of the insurance suitability module 106 determines (406) an insurance need factor associated with the life insurance applicant based on data received from the data collection module 104. The insurance need determination module 304 estimates the applicant's need for life insurance and ability to afford life insurance based on data such as income, net worth, marital status, number of children/dependents, prior/concurrent life insurance, credit history, and other similar attributes. The insurance need determination module 304 can also factor anecdotal or general population data (e.g., consumer price index by state or zipcode, tax rates, housing prices) into the determination. The insurance need determination module 304 can also determine an estimated amount of insurance that the insurance company is likely to underwrite based on data such as financial underwriting guidelines of the company.

In some embodiments, the insurance need determination module 304 also includes modeling techniques to determine future, or predictive, need for life insurance associated with the applicant based on the received data. For example, the insurance need determination module 304 can identify characteristics of the applicant (e.g., occupation, expected salary increase, number of children) and use probabilistic techniques in conjunction with known statistics to determine whether the applicant will need increased life insurance coverage in the future.

The insurance purchase determination module 306 of the insurance suitability module 106 determines (408) an insurance purchase probability associated with the life insurance applicant based on data received from the data collection module 104. The insurance purchase determination module 306 predicts the likelihood that the applicant will avoid letting a purchased life insurance policy lapse (i.e., persistency) over the lifetime of the policy. The insurance purchase determination module 306 can assess the persistency associated with similarly-situated life insurance policy holders or applicants to determine whether the applicant under evaluation will maintain his or her policy, once purchased. For example, the insurance purchase determination module 306 can determine lapse rates based on an interval of time (e.g., the first year that a policy is in force, the first five years) and/or based on increases in the cost of the policy, such as age-based premium changes. The insurance purchase determination module 306 can also factor in whether specific insurance products and/or product distribution channels are more likely to result in purchase of a policy than other insurance products.

Once each of the modules 302, 304, and 306 has completed its analysis of the data associated with the applicant, the insurance suitability profile generation module 308 combines (410) the output from the modules 302, 304, and 306 (e.g., insurance risk factors, insurance need factor, insurance purchase probability) to generate an insurance suitability profile. The insurance suitability profile represents a determination of whether the applicant has satisfied underwriting requirements of the insurance company and is eligible to be offered one or more insurance products. The insurance suitability profile generation module 308 can store the insurance suitability profile for each applicant in the database 112.

If the insurance suitability profile generation module 308 determines that, based on the output received from modules 302, 304 and 306, the applicant has satisfied the underwriting requirements, the insurance suitability profile generation module 308 can identify (412) one or more insurance products available to the applicant based on the generated profile and transmit an approval of the application, along with the identified insurance products, to the application processing module 110. In some embodiments, if the insurance suitability profile generation module 308 determines that the applicant has not satisfied any one of the respective requirements (e.g., the applicant's level of risk is too high, the applicant's life insurance need is too low, and/or the applicant's probability of purchasing life insurance is too low), the insurance suitability profile generation module 308 can transmit a rejection of the application to the application processing module 110. In some cases, the insurance suitability profile generation module 308 does not reject the application altogether, but can indicate that the application is subject to further underwriting requirements (e.g., a physical exam) before a decision can be made. The application processing module 110 can communicate with other computing systems to notify the applicant of the status of his/her application through any number of notification methods (e.g., email, telephone, letter).

An advantage of the automated data collection and insurance suitability profile generation process set forth above is greater efficiency and speed in processing insurance applications and determining insurance suitability. For example, the techniques described herein can result in much faster underwriting determinations when compared with traditional underwriting processes. Instead of requiring separate interactions with the applicant (e.g., in-person physical exam and/or blood testing) that can result in a lengthy underwriting process and delay in issuing an application decision, the systems and methods of the present application can render an underwriting decision in a matter of minutes after the applicant has submitted the application.

### Lead Generation

The techniques describe herein can be used not only to categorize individuals that have already submitted a life insurance application, but also to identify potential life insurance applications from a pool of individuals (e.g., for sales, marketing, and lead generation purposes). As mentioned above, in some embodiments, the data collection module 104 of the computing device 102 collects data associated with a pool of potential life insurance applicants from any or all of the data sources coupled to the computing device 102. For example, the data collection module 104 can access a lead generation database which contains general information about a pool of individuals identified through a variety of means (e.g., prior applicants, mailing lists, public record databases, responses to marketing outreach). The data collection module 104 can perform the same processing for the collection of potential applicants as it would for an individual that has already submitted an insurance application, and the module 104 can forward the data to the insurance suitability module 106 for analysis and generation of an insurance suitability profile as previously described with respect to FIGS. 3 and 4.

Once the insurance suitability profile is generated for a potential applicant, the insurance suitability module 106 can transmit the profile and other associated information to the lead generation module 108. The lead generation module 108 uses the profile to generate sales and marketing materials related to the potential applicant (e.g., applications for specific life insurance products, lists of insurance leads for brokers/agents).

The ability to generate an insurance suitability profile for a potential life insurance applicant provides significant value to the insurance company because it allows sales and marketing personnel to efficiently identify people that would be a good fit for particular insurance products. Instead of spending time and money on pursuing potential applicants that are not likely to apply for life insurance and purchase a product, the insurance company can target individuals realize higher placement of individuals into products from the company.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, a 3GPP Long Term Evolution (LTE) protocol, and/or other communication protocols.

Devices of the computing system can include, for example, a computer, a computer with a browser device, a telephone, an IP phone, a mobile device (e.g., cellular phone, personal digital assistant (PDA) device, laptop computer, tablet device, electronic mail device), and/or other communication devices. The browser device includes, for example, a computer (e.g., desktop computer, laptop computer) with a World Wide Web browser (e.g., Microsoft® Internet Explorer® available from Microsoft Corporation, Mozilla® Firefox available from Mozilla Corporation). Mobile computing device includes, for example, a Blackberry®, an iPhone®. IP phones include, for example, a Cisco® Unified IP Phone 7985G available from Cisco Systems, Inc, and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein.

What is claimed is:

1. A computerized method for categorizing a life insurance applicant to determine one or more suitable insurance products, the method comprising:
receiving, by a computing device, data associated with the life insurance applicant;
determining, by the computing device, a risk level for one or more insurance risk factors associated with the applicant based on the received data;
determining, by the computing device, an insurance need factor associated with the applicant based on the received data;
determining, by the computing device, an insurance purchase probability associated with the applicant based on the received data;
combining, by the computing device, the risk level, the insurance need factor, and the insurance purchase probability to generate an insurance suitability profile associated with the applicant; and
identifying, by the computing device, one or more insurance products available to the applicant based on the insurance suitability profile.

2. The method of claim 1, wherein the received data includes at least one of: demographic data, personal medical history data, family medical history data, pharmacy/prescription data, criminal record data, motor vehicle data, occupation data, travel data, financial data, beneficiary data, prior/concurrent insurance coverage data, insurance application data, substance abuse data, and accident data.

3. The method of claim 1, wherein the step of determining a risk level for one or more insurance risk factors comprises generating a predictive risk associated with future activities based on the received data.

4. The method of claim 1, wherein the risk level is a scaled value based on an aggregation of the one or more risk factors.

5. The method of claim 4, wherein the aggregation of the one or more risk factors includes weighting each risk factor according to predetermined criteria.

6. The method of claim 1, wherein the risk level represents the likelihood that an insurable event will happen to the applicant.

7. The method of claim 1, wherein the step of determining a risk level for one or more insurance risk factors comprises calibrating the risk level against known mortality information.

8. The method of claim 1, wherein the step of determining a risk level for one or more insurance risk factors comprises comparing the risk factors to risk factors associated with prior life insurance applicants.

9. The method of claim 1, wherein the step of determining an insurance need factor comprises generating a predictive need for future life insurance coverage based on the received data.

10. The method of claim 1, wherein the insurance need factor represents the applicant's need for life insurance and the applicant's ability to afford life insurance.

11. The method of claim 1, wherein the insurance need factor is determined based on one or more of: income, net worth, marital status, number of children/dependents, prior/concurrent life insurance, and credit history.

12. The method of claim 1, wherein the insurance purchase probability represents a likelihood that the applicant will avoid letting a purchased life insurance policy lapse.

13. The method of claim 1, wherein the insurance purchase probability relates to one or more identified insurance products.

14. The method of claim 1, wherein the insurance suitability profile represents a determination of whether the applicant has satisfied underwriting requirements of the insurance company and is eligible to be offered one or more insurance products.

15. The method of claim 1, wherein the insurance suitability profile indicates whether additional underwriting is required for the applicant.

16. The method of claim 1, further comprising transmitting, by the computing device to the applicant, information about the available life insurance products, if at least one available life insurance product is identified.

17. The method of claim 1, further comprising receiving, by the computing device from the applicant, a completed life insurance application.

18. The method of claim 1, further comprising storing, by the computing device, the received data for subsequent sales and marketing purposes.

19. A computerized system for categorizing a life insurance applicant to determine one or more suitable insurance products, the system comprising a server computing device configured to:
receive data associated with the life insurance applicant;
determine a risk level for one or more insurance risk factors associated with the applicant based on the received data;
determine an insurance need factor associated with the applicant based on the received data;
determine an insurance purchase probability associated with the applicant based on the received data;
combine the risk level, the insurance need factor, and the insurance purchase probability to generate an insurance suitability profile associated with the applicant; and
identify one or more insurance products available to the applicant based on the insurance suitability profile.

20. The system of claim 19, wherein the received data includes at least one of: demographic data, personal medical history data, family medical history data, pharmacy/prescription data, criminal record data, motor vehicle data, occupation data, travel data, financial data, beneficiary data, prior/concurrent insurance coverage data, insurance application data, substance abuse data, and accident data.

21. The system of claim 19, wherein the step of determining a risk level for one or more insurance risk factors comprises generating a predictive risk associated with future activities based on the received data.

22. The system of claim 19, wherein the risk level is a scaled value based on an aggregation of the one or more risk factors.

23. The system of claim 22, wherein the aggregation of the one or more risk factors includes weighting each risk factor according to predetermined criteria.

24. The system of claim 19, wherein the risk level represents the likelihood that an insurable event will happen to the applicant.

25. The system of claim 19, wherein the step of determining a risk level for one or more insurance risk factors comprises calibrating the risk level against known mortality information.

26. The system of claim 19, wherein the step of determining a risk level for one or more insurance risk factors comprises comparing the risk factors to risk factors associated with prior life insurance applicants.

27. The system of claim 19, wherein the step of determining an insurance need factor comprises generating a predictive need for future life insurance coverage based on the received data.

28. The system of claim 19, wherein the insurance need factor represents the applicant's need for life insurance and the applicant's ability to afford life insurance.

29. The system of claim 19, wherein the insurance need factor is determined based on one or more of: income, net worth, marital status, number of children/dependents, prior/concurrent life insurance, and credit history.

30. The system of claim 19, wherein the insurance purchase probability represents a likelihood that the applicant will avoid letting a purchased life insurance policy lapse.

31. The system of claim 19, wherein the insurance purchase probability relates to one or more identified insurance products.

32. The system of claim 19, wherein the insurance suitability profile represents a determination of whether the applicant has satisfied underwriting requirements of the insurance company and is eligible to be offered one or more insurance products.

33. The system of claim 19, wherein the insurance suitability profile indicates whether additional underwriting is required for the applicant.

34. The system of claim 19, wherein the computing device is configured to transmit, to the applicant, information about the available life insurance products, if at least one available life insurance product is identified.

35. The system of claim 19, further comprising receiving, by the computing device from the applicant, a completed life insurance application.

36. The system of claim 19, wherein the computing device is configured to store the received data for subsequent sales and marketing purposes.

37. A computer program product, tangibly embodied in a non-transitory computer readable storage medium, for categorizing a life insurance applicant to determine one or more suitable insurance products, the computer program product including instructions operable to cause a computing device to:
receive data associated with the life insurance applicant;
determine a risk level for one or more insurance risk factors associated with the applicant based on the received data;
determine an insurance need factor associated with the applicant based on the received data;
determine an insurance purchase probability associated with the applicant based on the received data;
combine the risk level, the insurance need factor, and the insurance purchase probability to generate an insurance suitability profile associated with the applicant; and
identify one or more insurance products available to the applicant based on the insurance suitability profile.
